(19) United States
(12) Patent Application Publication
(10) Pub. No.: US 2013/0240073 A1
(43) Pub. Date: Sep. 19, 2013

(54) Microfluidic Device for Altering a Fluid Flow and a Microfluidic System Including the Microfluidic Device

(71) Applicants: Huanming Xia, Singapore (SG); Zhiping Wang, Singapore (SG); Wei Fan, Singapore (SG); Zhenfeng Wang, Singapore (SG)

(72) Inventors: Huanming Xia, Singapore (SG); Zhiping Wang, Singapore (SG); Wei Fan, Singapore (SG); Zhenfeng Wang, Singapore (SG)

(73) Assignee: AGENCY FOR SCIENCE, TECHNOLOGY AND RESEARCH, Singapore (SG)

(21) Appl. No.: 13/822,743

(22) PCT Filed: Sep. 17, 2010
(86) PCT No.: PCT/SG2010/000346

§ 371 Date: May 28, 2013

(51) Int. Cl. G05D 7/01

(52) U.S. Cl. CPC G05D 7/0113
USPC 137/843

(57) ABSTRACT

In an embodiment, a microfluidic device for altering a fluid flow may be provided. The microfluidic device may include a chamber having a first chamber portion with an inlet configured to receive a fluid flow into the chamber; a second chamber portion with an outlet configured to permit an altered fluid flow out of the chamber, the second chamber portion defining a smaller chamber cross section compared to the first chamber portion; and at least one support structure with at least one support surface defining a division between the first chamber portion and the second chamber portion; and a diaphragm in the first chamber portion, the diaphragm displaceable between a position at the inlet and a position at the at least one support surface by the fluid flow. A microfluidic system including the microfluidic device may also be provided.

### TECHNICAL FIELD

Embodiments relate to a microfluidic device for altering a fluid flow and a microfluidic system including the microfluidic device.

### BACKGROUND

While macroscopic fluidic oscillators may have been well developed, the design options of the microfluidic oscillator may be limited. It may be because the flow behaviors in microfluidic devices may be different with that of macroscopic fluidic devices. Conventional macroscopic fluidic oscillators usually cannot be simply scaled down for microfluidic applications. Microfluidic oscillator designs may require different working principles.

Fluidic devices usually can be categorized into active or passive devices. Active devices may refer to devices actuated by external sources, for example, involving piezoelectric elements and magnetic devices. In this regard, active devices may require an external control element and may involve high fabrication cost.

Passive devices may refer to devices actuated by the flow of the fluid itself. Passive devices may be preferred over active devices because the devices may be self-contained. Traditional passive fluidic oscillators usually depend on the flow instabilities that occur at high Reynolds number (Re) to operate as desired. They may not be used for microfluidic applications because in microfluidic applications, the fluid flow is generally laminar (generally characterised by low Re). Unfortunately, known fluidic oscillators which are operable at sufficiently low Re for microfluidic applications are characterized by low operating frequencies which may not be desired.

### SUMMARY

In various embodiments, a microfluidic device for altering a fluid flow may be provided. The microfluidic device may include a chamber having a first chamber portion with an inlet configured to receive a fluid flow into the chamber; a second chamber portion with an outlet configured to permit an altered fluid flow out of the chamber, the second chamber portion defining a smaller chamber cross section compared to the first chamber portion; and at least one support structure with at least one support surface defining a division between the first chamber portion and the second chamber portion; and a diaphragm in the first chamber portion, the diaphragm displaceable between a position at the inlet and a position at the at least one support surface by the fluid flow.

In various embodiments, a microfluidic system may be provided. The microfluidic system may include a microfluidic device configured to alter a fluid flow including a chamber having a first chamber portion with an inlet configured to receive a fluid flow into the chamber; a second chamber portion with an outlet configured to permit an altered fluid flow out of the chamber, the second chamber portion defining a smaller chamber cross section compared to the first chamber portion; and at least one support structure with at least one support surface defining a division between the first chamber portion and the second chamber portion. The microfluidic device may further include a diaphragm in the first chamber portion, the diaphragm displaceable between a position at the inlet and a position at the at least one supporting surface by the fluid flow. The microfluidic system may further include an input passage connected upstream of the microfluidic device; and an output passage connected downstream of the microfluidic device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments of the invention are described with reference to the following drawings, in which:

FIG. 1 shows a cross-sectional view of a microfluidic device including a chamber and a support structure extending from an internal surface of the chamber according to an embodiment;

FIG. 2A shows a top view of a microfluidic device including a chamber having a first chamber portion and a second chamber portion, the second chamber portion defines a cross-sectional dimension smaller than the cross-sectional dimension of the first chamber portion according to an embodiment; FIG. 2B shows a cross-sectional view along line A-A of the microfluidic device as shown in FIG. 2A according to an embodiment;

FIG. 3 shows an exploded view of a microfluidic device including a support structure with a support surface having a plurality of grooves and protrusions, each of the plurality of grooves including a circumferential dimension smaller than each of the plurality of protrusions according to an embodiment;

FIG. 4A shows a perspective view of a portion of a microfluidic device including a chamber and an output passage coupled to the chamber, the chamber including a support structure with a support surface having a plurality of grooves and protrusions, each of the plurality of protrusions including a circumferential dimension smaller than each of the plurality of grooves according to an embodiment; FIG. 4B shows a perspective view of a portion of a microfluidic device including a chamber and an output passage coupled to the chamber, the chamber including a support structure with a support surface having a plurality of grooves and protrusions, each of the plurality of protrusions including a circumferential dimension comparable with each of the plurality of grooves according to an embodiment;

FIG. 5A shows an exploded view of a microfluidic device including a diaphragm with a plurality of openings formed along a circumference of the diaphragm according to an embodiment; FIG. 5B shows a cross-sectional view along line A-A of the microfluidic device as shown in FIG. 5A according to an embodiment;

FIGS. 6A to 6D show respective top views of a diaphragm with a plurality of openings according to an embodiment;

FIG. 7 shows a cross-sectional view of a bi-directional design microfluidic device including a chamber having a first chamber portion and a second chamber portion, the first chamber portion including a third chamber portion according to an embodiment;

FIG. 8 shows a microfluidic system including a microfluidic device positioned substantially perpendicular to a direction of fluid flow into the microfluidic device according to an embodiment;

FIG. 9 shows a microfluidic system including the microfluidic device as shown in FIG. 2B positioned in a fluid path of a feeding conduit for an in-line application according to an embodiment;

FIG. 10A shows a microfluidic system including a microfluidic device formed using three substrates according to an embodiment; FIG. 10B shows a microfluidic system including a microfluidic device formed using four substrates according to an embodiment;

FIG. 11A shows a microfluidic device including a chamber and a cover having a sealing component configured to seal the chamber according to an embodiment; FIG. 11B shows a microfluidic system including the microfluidic device as shown in FIG. 11A according to an embodiment;

FIG. 12A shows a photograph of the microfluidic system as shown in FIG. 11B according to an embodiment; FIG. 12B shows a schematic of a mixing profile of fluids in the microfluidic system as shown in FIG. 12A according to an embodiment;

FIG. 13 shows an output plot of a microfluidic device showing an oscillation frequency (f) at about 143 Hz according to an embodiment;

FIG. 14 shows a mixing profile of fluids in a boxed area of the microfluidic system as shown in FIG. 12B according to an embodiment;

FIGS. 15A and 15A′ shows respective results of mixing of fluids in a microfluidic system in a steady flow without the microfluidic device; FIGS. 15B and 15B′ shows respective results of improved mixing of fluids in the microfluidic system in an oscillatory flow according to an embodiment; FIG. 15C shows a result of an instant mixing of fluids in a microfluidic system in an oscillatory flow with a larger oscillation magnitude according to an embodiment;

FIG. 16 shows a schematic of a mixing profile of fluids in a microfluidic system including an input channel and a sample channel coupled to an inlet of the microfluidic device according to an embodiment;

FIG. 17 shows a cross-sectional view of a microfluidic system including a plurality of mixing chambers respectively separated from an output passage of an microfluidic device by a flexible wall according to an embodiment;

FIG. 18A shows a top view of a microfluidic system including four mixing chambers arranged in a configuration according to an embodiment; FIG. 18B shows a top view of a microfluidic system including four mixing chambers arranged in an alternative configuration according to an embodiment;

FIG. 19A shows a photograph of the microfluidic system as shown in FIG. 18B according to an embodiment; FIGS. 19B to 19E show a sequential mixing process of fluids in a mixing chamber according to an embodiment; and

FIG. 20 shows a top view of a microfluidic system configured to sequentially or simultaneously mix fluids in selected ones of a multiple number of mixing chambers in a fluidic network according to one embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Various embodiments provide an alternative microfluidic device which may overcome or at least alleviate some of the above-mentioned problems.

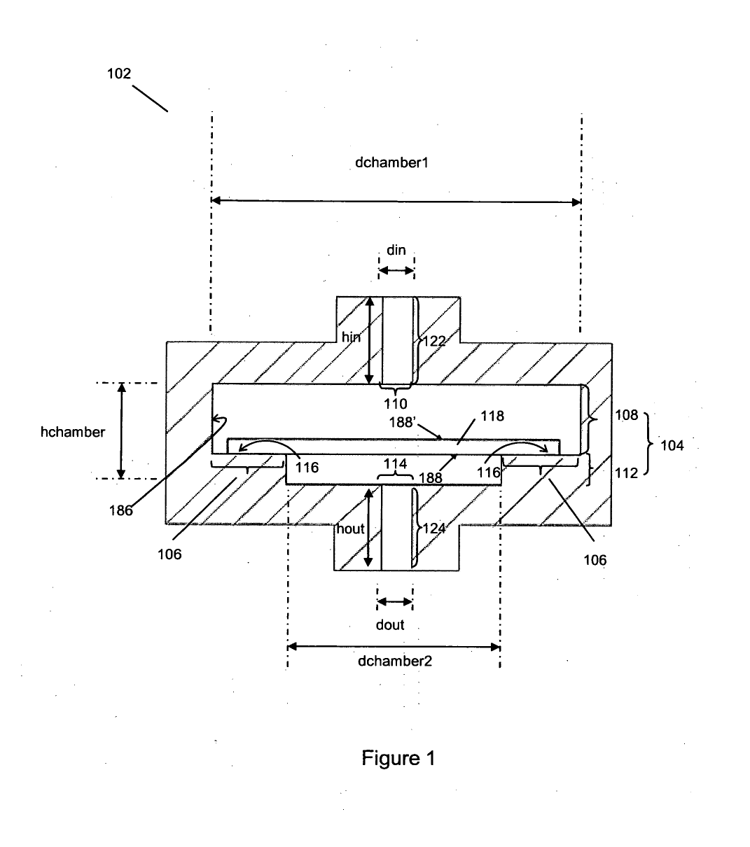

FIG. 1 shows a cross-sectional view of a microfluidic device 102 including a chamber 104 and at least one support structure 106 extending from an internal surface 186 of the chamber 104 according to an embodiment.

The microfluidic device 102 may be configured for altering a fluid flow and may be an oscillator, a mixer, a pump or a valve. The microfluidic device 102 may include the chamber 104 having a first chamber portion 108 with an inlet 110 configured to receive a fluid flow into the chamber 104; a second chamber portion 112 with an outlet 114 configured to permit an altered fluid flow out of the chamber 104, the second chamber portion 112 defining a smaller chamber cross-section compared to the first chamber portion 108; and the at least one support structure 106 with at least one support surface 116 defining a division between the first chamber portion 108 and the second chamber portion 112. Further, the microfluidic device 102 may include a diaphragm 118 positioned in the first chamber portion 108, the diaphragm 118 displaceable between a position at the inlet 110 and a position at the at least one support surface 116 by the fluid flow. The at least one support surface 116 and the diaphragm 118 may be configured to allow a fluid flow from the inlet 110 towards the outlet 114 thereby causing a deformation of the diaphragm 118 and a change in the hydrodynamic forces on the diaphragm 118 to render movement of the diaphragm 118 between the inlet 110 and the outlet 114 creating the altered fluid flow out of the chamber 104. If the microfluidic device 102 may be perceived or oriented with the inlet 110 above the outlet 114, the diaphragm 118 may be displaceable and essentially be found to be at a location at or below the inlet 110 and above the at least one support surface 116 in the course of its movement. In other words, the diaphragm 118 may be displaceable between the inlet 110 and the at least one support surface 116.

In an embodiment, the volume of the second chamber portion 112 may or may not be necessarily smaller than that of the first chamber portion 108. In this regard, the first chamber portion 108 and the second chamber portion 112 should be dimensioned such that the diaphragm 118 may be displaceable between the inlet 110 and the at least one support surface 116. Further, while the diaphragm 118 bounces back, it may not necessarily reach the inlet 110. As, an example, the diaphragm 118 may oscillate between the outlet 114 to somewhere below the inlet 110.

The altered fluid flow out of the chamber 104 may be at least one of oscillatory fluid flow and pulsating fluid flow for example. The pulsating fluid flow may typically be associated with cyclical or rhythmic flow in the same direction while the oscillatory fluid flow may be similar to the pulsating fluid flow but the fluid flow may appear intermittent or to be flowing in different directions for two halves of a cycle. Any other suitable fluid flow which may be different from the input fluid flow may also be adopted depending on user and design requirements.

In a default position where there is no fluid flow into the chamber 104, the diaphragm 118 may be configured to be supported onto the at least one support surface 116 and may or may not be permanently connected or attached to any part of the at least one support surface 116 or the chamber 104. In the presence of fluid flow into the chamber 104, the diaphragm 118 may be displaceable within the first chamber portion 108 so as to facilitate the fluid flow from the first chamber portion 108 into the second chamber portion 112. The diaphragm 118 may be deformable under the pressure of the fluid flow on the diaphragm 118. In other words, the diaphragm 118 may be deformed when there is a difference in pressure between two substantially opposing faces 188, 188′ of the diaphragm 118. Deformation of the diaphragm 118 may alter the pattern of the fluid flow in the chamber 104 and change the hydrodynamic forces exerted on the diaphragm 118. As a result, the lifting force on the diaphragm 118 may increase pushing of the diaphragm 118 away from the second chamber portion 112 and towards the inlet 110, thus momentarily blocking further fluid flowing into the chamber 104 from the inlet 110. The displacement of the diaphragm 118 may further change the flow and the hydrodynamic forces exerted on the diaphragm 118. As a result, the diaphragm 118 tends to restore its original shape. As the pressure on the side 188 of the diaphragm 118 facing the second chamber portion 112 may be reduced, the diaphragm 118 may be pushed downstream and deformed again by the fluid flowing in at the inlet 110. The cycle may accordingly repeat and thereby generate an altered flow or a pulsed flow downstream of the chamber 104. Fluid may exit the chamber 104 through the outlet 114 in such a manner where the fluid downstream of the microfluidic device 102 may be characterised by an altered flow or a pulsed flow of a relatively high frequency. At the same time, the microfluidic device 102 may be operable at Re found in most microfluidic applications.

As an example, the diaphragm 118 may or may not be hinged or chained at any suitable portion of the at least one support surface 116 or any portion of the chamber 104 as long as the diaphragm 118 may be capable of oscillating in response to the change of pressure between the first chamber portion 108 and the second chamber portion 112. Conventional practice is inclined towards non-moving or stationary features to generate alteration of fluid flow in passive devices as free components, that is, components unconnected to other components of the device, may introduce undesirable uncontrollable elements into the system. Here, it is boldly proposed to provide a diaphragm 118 that is not connected to the chamber 104, and harness the somewhat random behavior of a free component to provide a desired result. The absence of a connection, whether in the form of a hinge or chain, further advantageously simplifies fabrication of the device and hence reduces the cost of fabrication, without compromising performance of the device. As a further example, the diaphragm 118 may be substantially flat in shape or planar. The diaphragm 118 may also be configured such that the surface area may be relatively large compared to the thickness of the diaphragm 118. The diaphragm 118 may also be of any suitable shape or dimension as long as it may be supported onto the at least one support surface 116. The diaphragm 118 may be of a deformable material such that under the pressure of an incoming flow into the chamber 104, the diaphragm 118 may deform and become convex downstream. Then deformation of the diaphragm 118 may further change the fluid flow and the hydrodynamic forces such as the lifting force, which may push the diaphragm 118 back. In an embodiment, the diaphragm 118 may include a substantially flat shape so as to facilitate the deformation of the diaphragm 118 and to produce a relatively significant change in the hydrodynamic forces, which may ease the occurrence of the oscillation. Further, the diaphragm 118 may be shaped so as to complement the shape and dimension of the first chamber portion 108 and the second chamber portion 112 so as to optimise the amount of movement within the chamber 104. In addition, the diaphragm 118 may also be shaped so that the respective volume of the available space between the diaphragm 118 and the inlet 110 and between the diaphragm 118 and the outlet 114 may be optimised when the diaphragm 118 may be displaced towards the inlet 110 or towards the outlet 114 respectively.

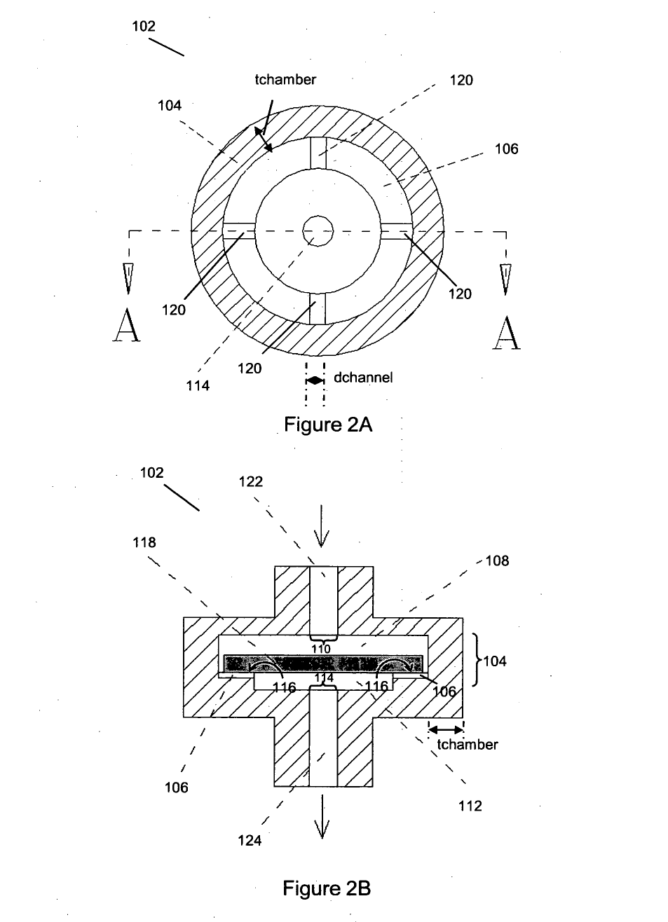

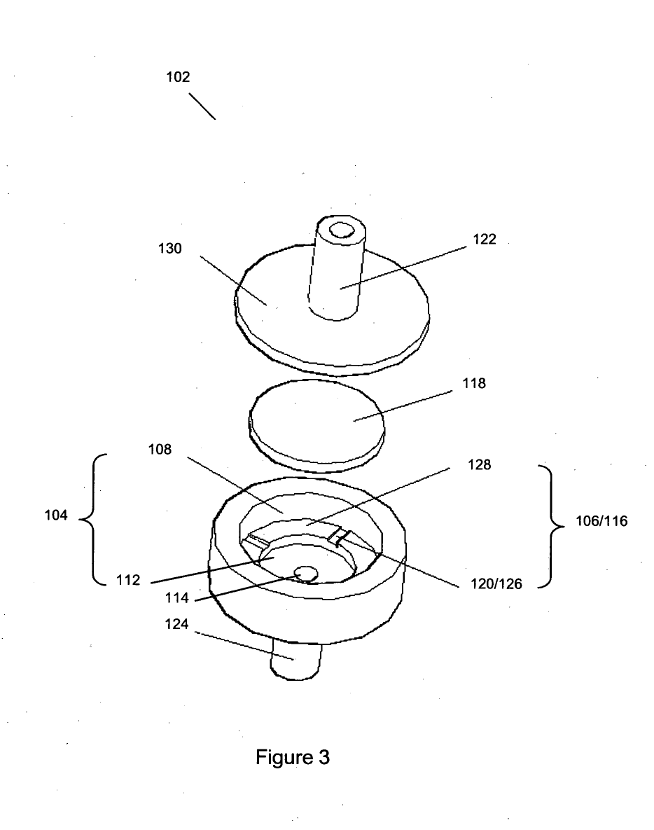

The microfluidic device 102 may be observed to exhibit three types of behavior depending on the pressure applied to pump fluid into the microfluidic device 102. Below a first critical pressure, there is no observation of substantial alteration in the fluid flow out of the microfluidic device 102, and the fluid flow out of the microfluidic device 102 may be described as stable. Above a second critical pressure that is higher than the first critical pressure, the diaphragm 118 is observed to block the outlet 114. Hence, the microfluidic device 102 may be described as having an operational pressure range between the first critical pressure and the second critical pressure as a fluid flow alteration device, an oscillator, or a mixing promotor. And the same microfluidic device 102 may be described as a valve to close off fluid flow above the second critical pressure. The operational pressure range may be set by varying the depth of the first chamber portion 108, the depth of the second chamber portion 112, and the cross-sectional area of the groove 126 (as subsequently shown in FIG. 3) or channels 120 (as subsequently shown in FIG. 2A). For example, the first critical pressure may be reduced with the reduction in the depth of the first chamber portion 108, and/or reduction of the cross-sectional area of the groove 126 or channels 120 as mentioned earlier. The second critical pressure may be reduced with the reduction in the depth of the second chamber portion 112, and/or reduction in the cross-sectional area of the groove 126 or channels as mentioned earlier.

The diaphragm 118 may include a material selected from a group consisting of silicone rubber, natural rubber, latex, nitrile rubber, thermoplastic polyurethane, and elastic metal for example. The diaphragm 118 may also be of a bio-compatible material so as to be suitable for biological applications. As an example, the diaphragm 118 may be a soft, rubber dome with a flexible rim. As a further example, the diaphragm 118 may be a membrane, or a discoid. In some embodiments, the material or dimension of the diaphragm 118 may be chosen to provide a desired degree of stiffness, which in turn may determine the oscillating frequency.

The first chamber portion 108 may include a cross-sectional dimension (as denoted by “dchamber1”) in a range of typically about 1 to about 10 mm, for example. As shown in FIG. 1, the second chamber portion 112 may define a cross-sectional dimension (denoted by “dchamber2”) smaller than the cross-sectional dimension of the first chamber portion 108. However, depending on the size or shape of the at least one support structure 106, the second chamber portion 112 may also define a nominal or average cross-sectional dimension smaller than the cross-sectional dimension of the first chamber portion 108. The chamber 104 may also include a height (as denoted by “hchamber”) of typically above 1 mm, for example.

The at least one support structure 106 may include one support structure or may include a plurality of support structures depending on user and design requirements. In the case of the plurality of support structures, each of the plurality of support structures may be positioned adjacent to each other or may be positioned spaced apart at a fixed or varying predetermined distance away from each other. Further, each of the plurality of support structures may be arranged so as to be at a substantially same level or height along the internal surface 186 of the chamber 104. However, each of the plurality of support structures may also be arranged at varying heights along the internal surface 186 of the chamber 104 as long as the diaphragm 118 may be supported thereon.

The at least one support structure 106 and the diaphragm 118 may be configured in any suitable manner so as to allow a fluid flow from the first chamber portion 108 to the second chamber portion 112. As an example, the at least one support structure 106 may define at least one channel (not shown) communicating between the first chamber portion 108 and the second chamber portion 112. As a further example, the at least one channel may be extended from the support surface 116 such that fluid from the first chamber portion 108 may be directed to flow between the at least one channel and a side 188 of the diaphragm 118 as it enters the second chamber portion 112. In another example, the at least one channel may be formed in any suitable design on the support surface 116. The number of channels may vary depending on the desired speed or rate of fluid flow or oscillation rate of the diaphragm 118 for example.

The microfluidic device 102 may further include an input passage 122 coupled upstream of the inlet 110 such that the input passage 122 is configured to channel the fluid flow into the first chamber portion 108. The cross-sectional dimension (as denoted by “din”), the height (as denoted by “hin”) and cross-sectional shape of the input passage 122 may vary depending on user and design requirements. The cross-sectional shape of the input passage 122 may be substantially circular, but any other suitable shapes such as square, triangle, rectangle, oval may also be used.

The microfluidic device 102 may further include an output passage 124 coupled downstream of the outlet 114 such that the output passage 124 is configured to channel the fluid flow out of the second chamber portion 112. The cross-sectional dimension (as denoted by “dout”), the height (as denoted by “hout”) and cross-sectional shape of the output passage 124 may vary depending on user and design requirements. The cross-sectional shape of the output passage 124 may be substantially circular, but any other suitable shapes such as square, triangle, rectangle, oval may also be used.

The cross-sectional dimension of the input passage 122 may be similar or different from the cross-sectional dimension of the output passage 124 depending on user and design requirements. The height of the input passage 122 may be similar or different from the height of the output passage 124 depending on user and design requirements. Similarly, the cross-sectional shape of the input passage 122 may be similar or different from the cross-sectional shape of the output passage 124 depending on user and design requirements.

The microfluidic device 102 may be formed as an integrated device or may be formed from separate portions or substrates. The microfluidic device 102 may be formed from any suitable material or combination of material such as polymeric material or metal materials, for example.

FIG. 2A shows a top view of a microfluidic device 102 including a chamber 104 having a first chamber portion 108 and a second chamber portion 112, the second chamber portion 112 defines a cross-sectional dimension smaller than the cross-sectional dimension of the first chamber portion 108 according to an embodiment. FIG. 2B shows a cross-sectional view along line A-A of the microfluidic device 102 as shown in FIG. 2A according to an embodiment.

The microfluidic device 102 as shown in FIGS. 2A and 2B may be similar to the microfluidic device 102 as shown in FIG. 1.

In FIGS. 2A and 2B, the microfluidic device 102 may include the chamber 104 having a first chamber portion 108 with an inlet 110 configured to receive a fluid flow into the chamber 104; a second chamber portion 112 with an outlet 114 configured to permit an altered fluid flow out of the chamber 104, the second chamber portion 112 defining a smaller chamber cross section compared to the first chamber portion 108; and the at least one support structure 106, with the at least one support surface 116 defining a division between the first chamber portion 108 and the second chamber portion 112. Further, the microfluidic device 102 may include a diaphragm 118 positioned in the first chamber portion 108, the diaphragm 118 displaceable between a position at the inlet 110 and a position at the at least one support surface 116 by the fluid flow. The at least one support surface 116 and the diaphragm 118 may be configured to allow a fluid flow from the inlet 110 towards the outlet 114 thereby causing a deformation of the diaphragm 118 and a change in the hydrodynamic forces on the diaphragm 118 to render movement of the diaphragm 118 between the inlet 110 and the outlet 114 creating the altered fluid flow out of the chamber 104. In other words, if the microfluidic device 102 is perceived or oriented with the inlet 110 above the at least one support surface 106, the diaphragm 118 is displaceable between a position below the inlet 110 and a position above the at least one support surface 116. The diaphragm 118 is sized such that the diaphragm 118 may be at least supported by the at least one support surface 116 in a default position.

The support surface 116 may include four channels 120 communicating between the first chamber portion 108 and the second chamber portion 112. The higher the number of channels 120, the higher the flow rate through the microfluidic device 102. The number of channels 120 may vary depending on user and design requirements. Each of the four channels 120 may include a same or different circumferential dimension (as denoted by “dchannel”). However, the circumferential dimension of each of the four channels 120 may vary depending on user and design requirements. In addition, for each of the four channels 120, the circumferential dimension may be uniform along the length of the channel 120 as shown in FIG. 2A or may vary along the length of the channel 120, for example, tapered, wavy and others.

In a default position where there is no fluid flow into the chamber 104, the diaphragm 118 may be configured to be supported onto the support surface 116 and may be separated from or unconnected to the chamber 104. In the presence of fluid flow into the chamber 104, the diaphragm 118 may be displaceable within the first chamber portion 108 so as to facilitate the fluid flow from the first chamber portion 108 into the second chamber portion 112.

The microfluidic device 102 may further include an input passage 122 coupled to the inlet 110 such that the input passage 122 is configured to channel the fluid flow into the first chamber portion 108. The microfluidic device 102 may further include an output passage 124 coupled to the outlet 114 such that the output passage 124 is configured to channel the fluid flow out of the second chamber portion 112. The direction of fluid flow is as shown by the arrows in FIG. 2B.

The dimensions of the wall of the chamber 104 (as denoted by “tchamber”) may vary between about 2 to about 5 mm, for example. The dimensions of the wall of the chamber 104 may vary depending on the material used or may also vary depending on user and design requirements.

FIG. 3 shows an exploded view of a microfluidic device 102 including a support structure 106 with a support surface 116 having a plurality of grooves 126 and protrusions 128, each of the plurality of grooves 126 including a circumferential dimension smaller than each of the plurality of protrusions 128 according to an embodiment. The microfluidic device 102 as shown in FIG. 3 is similar to the microfluidic device 102 as shown in FIGS. 2A and 2B.

In FIG. 3, the microfluidic device 102 may include the chamber 104 having a first chamber portion 108 with an inlet (not shown) configured to receive a fluid flow into the chamber 104; a second chamber portion 112 with an outlet 114 configured to permit an altered fluid flow out of the chamber 104, the second chamber portion 112 defining a smaller chamber cross section compared to the first chamber portion 108; and the support structure 106 with the support surface 116 defining a division between the first chamber portion 108 and the second chamber portion 112. Further, the microfluidic device 102 may include a diaphragm 118 positioned in the first chamber portion 108, the diaphragm 118 displaceable between a position at the inlet and a position at the support surface 116 by the fluid flow.

The diaphragm 118 may be configured to be supported onto the support surface 116 such that the diaphragm 118 may be in contact with the chamber 104 or may also be separated from or unconnected to the chamber 104. In the presence of fluid flow into the chamber 104, the diaphragm 118 may be displaceable within the first chamber portion 108 so as to facilitate the fluid flow from the first chamber portion 108 into the second chamber portion 112.

Like in FIGS. 2A and 2B, the second chamber portion 112 as shown in. FIG. 3, may define a cross-sectional dimension substantially smaller than the cross-sectional dimension of the first chamber portion 108 thereby forming the support structure 106. The support structure 106 may define a plurality of channels 120 communicating between the first chamber portion 108 and the second chamber portion 112. As an example, each of the plurality of channels 120 may be formed on the support surface 116 of the support structure 106. The number of channels 120 and the arrangement of the channels 120 may vary depending on the desired speed or rate of fluid flow or desired oscillation rate of the diaphragm 118 for example.

The microfluidic device 102 may further include an input passage 122 coupled to the inlet such that the input passage 122 may be configured to channel the fluid flow into the first chamber portion 108. The dimension and cross-sectional shape of the input passage 122 may vary depending on user and design requirements. The microfluidic device 102 may further include an output passage 124 coupled to the outlet 114 such that the output passage 124 may be configured to channel the fluid flow out of the second chamber portion 112. The dimension and cross-sectional shape of the output passage 124 may also vary depending on user and design requirements.

The microfluidic device 102 may further include a cover 130 disposed over the inlet and configured to at least substantially cover the diaphragm 118 within the chamber 104. The cover 130 may include a cover opening (not shown), the cover opening may be positioned to align with the input passage 122 so as to allow the fluid flow into the chamber 104 through the cover opening and the input passage 122. The cover 130, the diaphragm 118 and the chamber 104 may be formed using same or different materials.

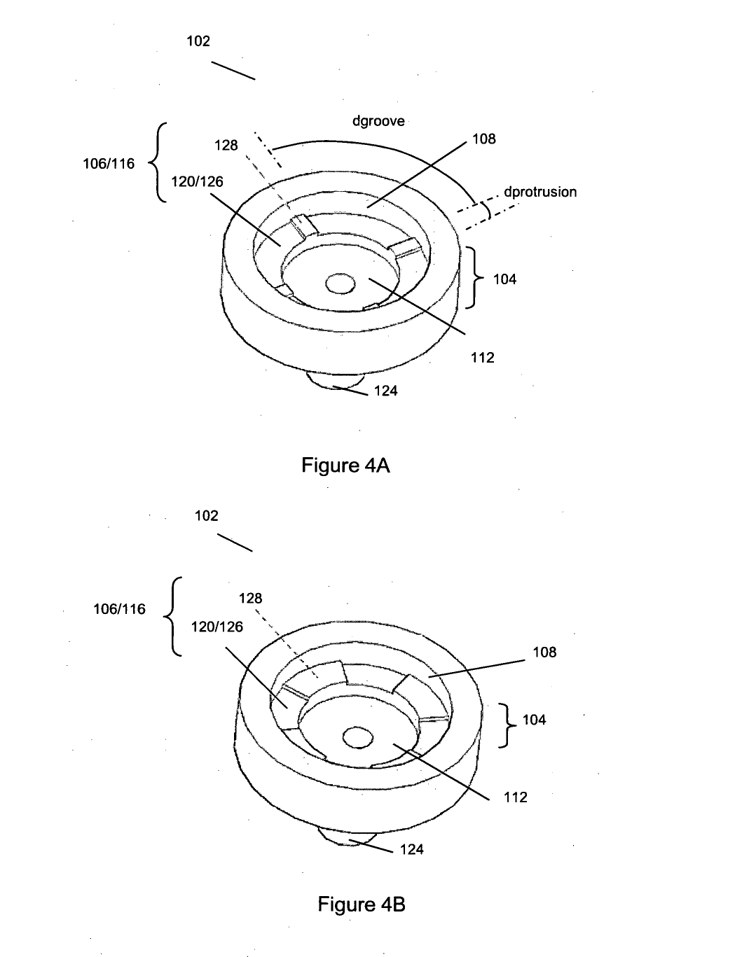

FIG. 4A shows a perspective view of a portion of a microfluidic device 102 including a chamber 104 and an output passage 124 coupled to the chamber 104, the chamber 104 including a support structure 106 with a support surface 116 having a plurality of grooves 126 and protrusions 128, each of the plurality of protrusions 128 including a circumferential dimension smaller than each of the plurality of grooves 126 according to an embodiment.

As shown in FIG. 4A, the support surface 116 may include four grooves 126 and four protrusions 128. However, the number of grooves 126 and protrusions 128 may vary depending on user and design requirements. Each of the grooves 126 and protrusions 128 may be positioned in an alternating manner around the circumference of the support surface 116. These combinations of grooves 126 and protrusions 128 defines the plurality of channels 120 communicating between the first chamber portion 108 and the second chamber portion 112.

The preferred number of protrusions 128 or grooves 126 is above 2. The protrusions 128 or grooves 126 may be distributed evenly or unevenly around the circumference of the support surface 116. The circumferential dimension (as denoted by “dprotrusion”) of each of the protrusions 128 may be equal to, or smaller, or larger than each of the circumferential dimension (as denoted by “dgroove”) of each of the grooves 126. For example, the circumferential dimension of each of the protrusions 128 may vary between about 1 to about 89 degree in the case of four protrusions 128. FIG. 4A shows an example that the circumferential dimension of each protrusion 128 is smaller than that of each groove 126. FIG. 4B shows an example that the circumferential dimension of each protrusion 128 is about the same with that of each groove 126. The grooves 126 and protrusions 128 may be formed such that respective portions of the support surface 116 may be removed. The extent of the removal of the portions of the support surface 116 may vary depending on user and design requirements. The removal may be done in one step or may be done in many steps, removing different amount of portions of the support surface 116 at each time.

The circumferential dimension of each of the four protrusions 128 or four grooves 126 may be substantially uniform along the entire length of the grooves 126 or protrusions 128 as shown in FIG. 4B or may vary along the length of the grooves 126 or protrusions 128, for example tapered or patterned. The design of each of the four protrusions 128 or four grooves 126 may vary depending on user and design requirements.

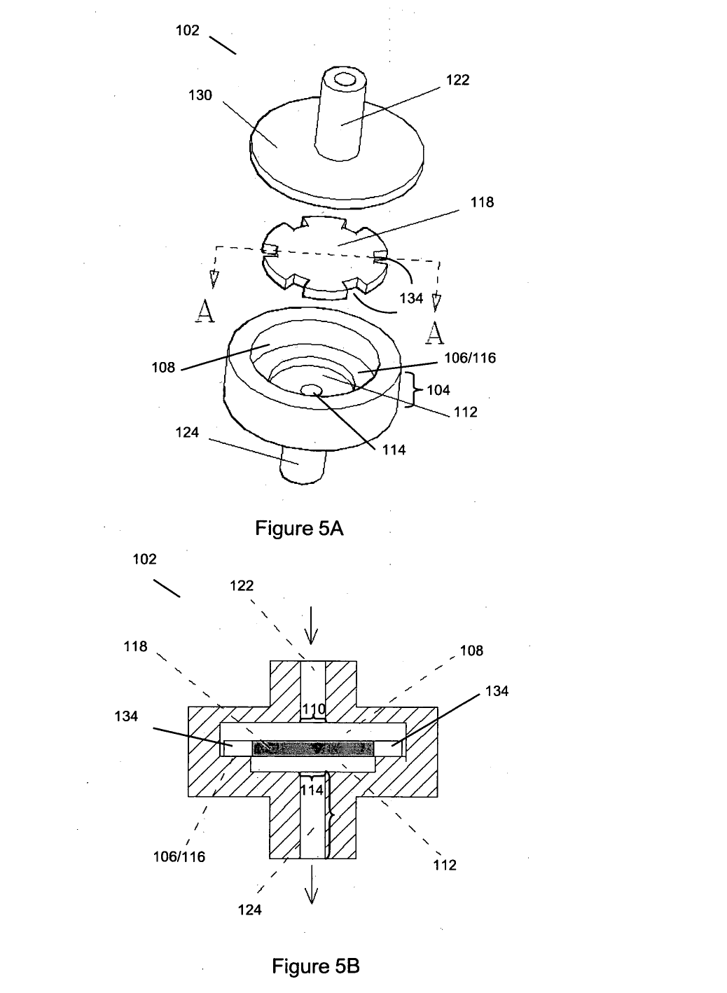

FIG. 5A shows an exploded view of a microfluidic device 102 including a diaphragm 118 with a plurality of openings 134 formed along a circumference of the diaphragm 118 according to an embodiment and FIG. 5B shows a cross-sectional view along line A-A of the microfluidic device 102 as shown in FIG. 5A according to an embodiment.

The microfluidic device 102 as shown in FIGS. 5A and 5B may be similar to the microfluidic device 102 as shown in FIG. 3 except that in FIG. 5, the support surface 116 may be substantially even and does not include any groove or protrusion and that the diaphragm 118 may include a plurality of openings 134. The support surface 116 and the diaphragm 118 may be configured in any suitable manner as long as there may be at least one channel (not shown) communicating between the first chamber portion 108 and the second chamber portion 112.

As shown in FIG. 5A, the diaphragm 118 includes six openings 134 formed along the circumference of the diaphragm 118. However, any suitable number of openings 134 may be formed along the circumference of the diaphragm 118 or within the diaphragm 118. Each of the six openings 134 may appear to be substantially square in shape. Each of the six openings 134 may include the same or different shape from each other. In this regard, each of the six openings 134 may include any other suitable shape or as long as the support structure 106 and the diaphragm 118 may be configured to allow a fluid flow from the first chamber portion 108 to the second chamber portion 112. Each of the six openings 134 may also be spaced apart from each other at a fixed or varying distance depending on user and design requirements. The six openings may also be formed in a combination along the circumference and within the diaphragm 118.

In FIGS. 5A and 5B, the microfluidic device 102 may include the chamber 104 having the first chamber portion 108 with an inlet 110 configured to receive a fluid flow into the chamber 104; the second chamber portion 112 with an outlet 114 configured to permit an altered fluid flow out of the chamber 104, the second chamber portion 112 defining a smaller chamber cross section compared to the first chamber portion 108; and the support structure 106 with a support surface 116 defining a division between the first chamber portion 108 and the second chamber portion 112. Further, the microfluidic device 102 may include the diaphragm 118 positioned in the first chamber portion 108, the diaphragm 118 displaceable between a position at the inlet 110 and a position at the at least one support surface 116 by the fluid flow.

The diaphragm 118 may be configured to be supported onto the support surface 116 and may be separated from or unconnected to the chamber 104. In the presence of fluid flow into the chamber 104, the diaphragm 118 may be displaceable within the first chamber portion 108 so as to facilitate the fluid flow from the first chamber portion 108 into the second chamber portion 112.

As shown in FIGS. 5A and 5B, the second chamber portion 112 may define a cross-sectional dimension substantially smaller than the cross-sectional dimension of the first chamber portion 108, thereby forming the support structure 106 with the support surface 116 defining the division between the first chamber portion 108 and the second chamber portion 112.

The microfluidic device 102 may further include an input passage 122 coupled to the inlet 110 such that the input passage 122 is configured to channel the fluid flow into the first chamber portion 108. The microfluidic device 102 may further include an output passage 124 coupled to the outlet 114 such that the output passage 124 is configured to channel the fluid flow out of the second chamber portion 112.

The microfluidic device 102 may further include a cover 130 disposed over the inlet 110 and configured to at least substantially cover the diaphragm 118 within the chamber 104. The cover 130 may include a cover opening (not shown), the cover opening is positioned to align with the input passage 122 so as to allow the fluid flow into the chamber 104 through the cover opening and the input passage 122.

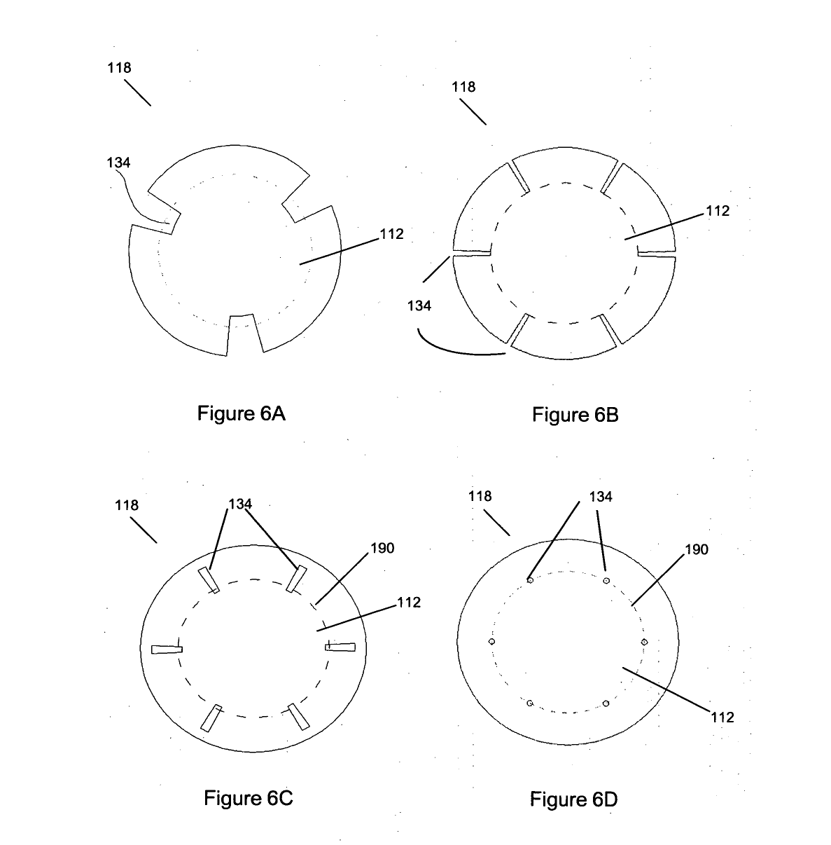

FIGS. 6A to 6D show respective top views of a diaphragm 118 with a plurality of openings 134 according to an embodiment.

FIG. 6A shows a diaphragm 118 which is substantially circular in shape. The diameter of the diaphragm 118 may be at least larger than the diameter of the second chamber portion 112 so that the diaphragm 118 may be supported on a substantially even support surface formed by the difference in cross-section between the first chamber portion (shown in the foreground) and the second chamber portion 112 (faintly shown in the background). Three substantially rectangular openings or cutouts 134 may be formed along a circumference of the diaphragm 118 and sized so as to allow fluid flow from the first chamber portion to the second chamber portion 112. The number, shape and positioning of the openings 134 may vary depending on user and design requirements.

Like in FIG. 6A, FIG. 6B shows a diaphragm 118 which is also substantially circular in shape. Six substantially rectangular openings 134 or cutouts may be formed along a circumference of the diaphragm 118 so as to allow fluid flow from the first chamber portion (shown in the foreground) to the second chamber portion 112 (faintly shown in the background). The circumferential dimension of each of the openings 134 may be smaller than that as shown in FIG. 6A. The circumferential dimension, number and shape of the openings 134 may vary depending on user and design requirements.

Like in FIG. 6B, FIG. 6C shows a diaphragm 118 which is substantially circular in shape. Unlike the openings 134 formed along a circumference of the diaphragm 118 as shown in FIG. 6B, the six substantially rectangular openings 134 as shown in FIG. 6C may be formed within the diaphragm 118 so as to allow fluid flow from the first chamber portion (shown in the foreground) to the second chamber portion 112 (faintly shown in the background). Each of the six substantially rectangular openings 134 may be positioned within the diaphragm 118 such that a portion of each of the six substantially rectangular openings 134 are aligned with an edge 190 of the second chamber portion 112 so as to allow the fluid flow from the first chamber portion to the second chamber portion 112. The number, positioning, dimension and shape of each of the openings 134 may vary depending on user and design requirements.

Like in FIG. 6C, FIG. 6D shows a diaphragm 118 which is substantially circular in shape. Instead of six substantially rectangular openings 134 formed within the diaphragm 118 as shown in FIG. 6C, six substantially circular openings 134 may be formed within the diaphragm 118 so as to allow fluid flow from the first chamber portion (shown in the foreground) to the second chamber portion 112 (faintly shown in the background). Each of the six substantially circular openings 134 may be positioned within the diaphragm 118 such that the openings 134 are aligned with an edge 190 of the second chamber portion 112 so as to allow the fluid flow from the first chamber portion 108 to the second chamber portion 112. The dimension and shape of each of the openings 134 may vary depending on user and design requirements.

FIGS. 6A to 6D shows that the diaphragm 118 may be substantially circular in shape. However, the diaphragm 118 may also include any other suitable shapes for example non-circular depending on user and design requirements. In addition, openings 134 on the diaphragm 118 may be formed as perforations or cut-outs by any suitable method.

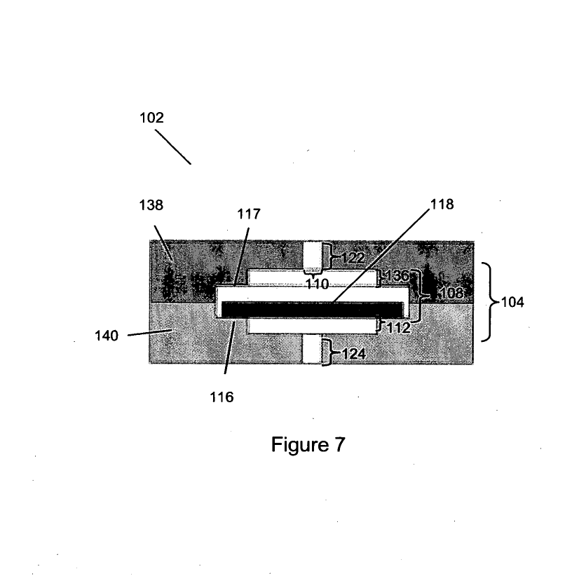

FIG. 7 shows a cross-sectional view of a bi-directional design microfluidic device 102 including a chamber 104 having a first chamber portion 108 and a second chamber portion 112, the first chamber portion 108 including a third chamber portion 136 according to an embodiment;

The microfluidic device 102 as shown in FIG. 7 is a modification of the microfluidic device 102 as shown in FIG. 2B. In the microfluidic device 102 as shown in FIG. 7, the first chamber portion 108 may further include the third chamber portion 136 leading from the inlet 110, the third chamber portion 136 defining a smaller chamber cross section compared to the rest of the first chamber portion 108.

As an example of the bi-directional design microfluidic device 102 as shown in FIG. 7, the third chamber portion 136 may include a chamber volume substantially similar to that of the second chamber portion 112. And the cross-sectional dimension of the third chamber portion 136 may be substantially the same or different as the cross-sectional dimension of the second chamber portion 112. In addition, the first chamber portion 108 may include a cross-sectional dimension larger than each of the respective second chamber portion 112 or third chamber portion 136. In this regard, this may provide symmetry to the microfluidic device 102 such that it may be possible to orientate the microfluidic device 102 in any direction as the diaphragm 118 may be positioned either on the support surface 116 defining a division between the first chamber portion 108 and the second chamber portion 112 as shown in FIG. 7 or on a further support surface 117 defining a division between the third chamber portion 136 and the first chamber portion 108. Advantageously, the microfluidic device 102 may be provided with a non-symmetrical design, for example, by having the cross-sectional dimension of the third chamber portion 136 different with the cross-sectional dimension of the second chamber portion 112, such that the operating pressure range and oscillation frequency may be different for the same microfluidic device 102 operating in different directions. In other words, the microfluidic device 102 advantageously enable a microfluidic system to be designed such that it may create a first altered fluid flow for fluid flow in one direction and a second altered fluid flow for fluid flow in a second direction, in which the first altered fluid flow and the second fluid flow are different, for example, in their respective oscillation frequencies. Advantageously, the microfluidic device 102 may be configured to provide an altered fluid flow in one direction and to provide a valving effect in another direction.

The bi-directional design microfluidic device 102 as shown in FIG. 7 may be formed by aligning two separate substrates or by a single substrate. In the case of two separate substrates, the input passage 122, the third chamber portion 136 and a part of the first chamber portion 108 may be formed in a first substrate 138 and the output passage 124, the second chamber portion 112 and the remaining part of the first chamber portion 108 may be formed in a second substrate 140. The first substrate 138 and the second substrate 140 may be of the same material or different material. The diaphragm 118 may be positioned within the first chamber portion 108 such that the diaphragm 118 may be supported on the support surface 116 or on the further support surface 117.

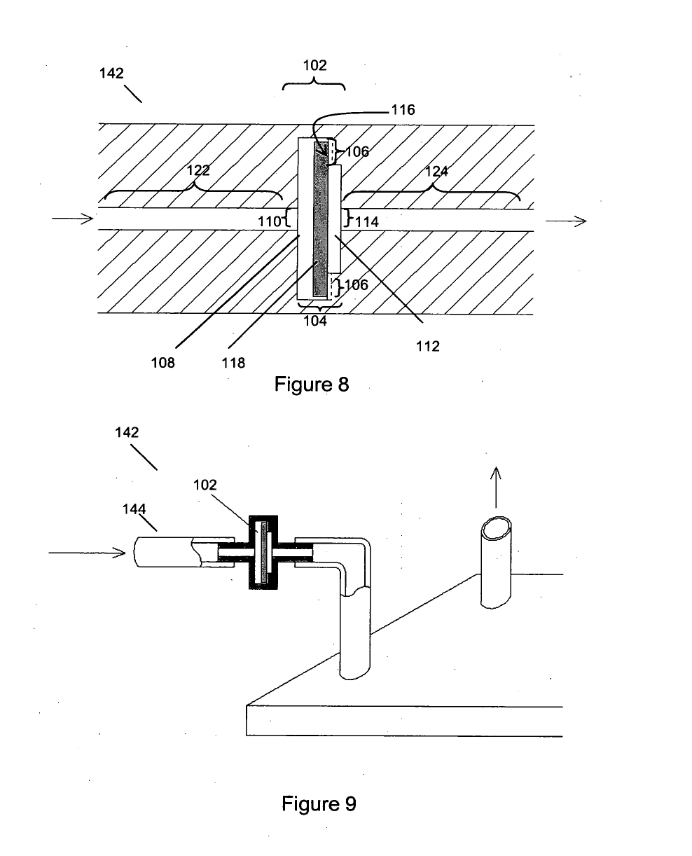

FIG. 8 shows a microfluidic system 142 including a microfluidic device 102 positioned substantially perpendicular to a direction of fluid flow into the microfluidic device 102 according to an embodiment.

In FIG. 8, the microfluidic device 102 may be shown to be embedded within the microfluidic system 142. The microfluidic device 102 may include a chamber 104 having a first chamber portion 108 with an inlet 110 configured to receive a fluid flow into the chamber 104; a second chamber portion 112 with an outlet 114 configured to permit an altered fluid flow out of the chamber 104, the second chamber portion 112 defining a smaller chamber cross section compared to the first chamber portion 108; and a support structure 106 with a support surface 116 defining a division between the first chamber portion 108 and the second chamber portion 112. The microfluidic device 102 may further include a diaphragm 118 positioned in the first chamber portion 108, the diaphragm 118 displaceable between a position at the inlet 110 and a position at the support surface 116 by the fluid flow. Further, the microfluidic system 142 may include an input passage 122 connected upstream of the microfluidic device 102; and an output passage 124 connected downstream of the microfluidic device 102. The direction of the fluid flow may be as shown by the arrows in FIG. 8.

FIG. 9 shows a microfluidic system 142 including the microfluidic device 102 as shown in FIG. 2B positioned in a fluid path of a feeding conduit or feeding duct 144 for an in-line application according to an embodiment.

The microfluidic device 102 or microfluidic oscillator may be used as a part of a microfluidic system 142 or may also be used as a standalone, plug-and-play device. As shown in FIG. 9, the microfluidic device 102 may be mounted in line with the feeding duct 144 to provide an oscillatory flow. The direction of the fluid flow may be as shown by the arrows in FIG. 9. The microfluidic device 102 may be connected at any suitable or desired position along any fluid path within the microfluidic system 142 to provide the altered fluid flow.

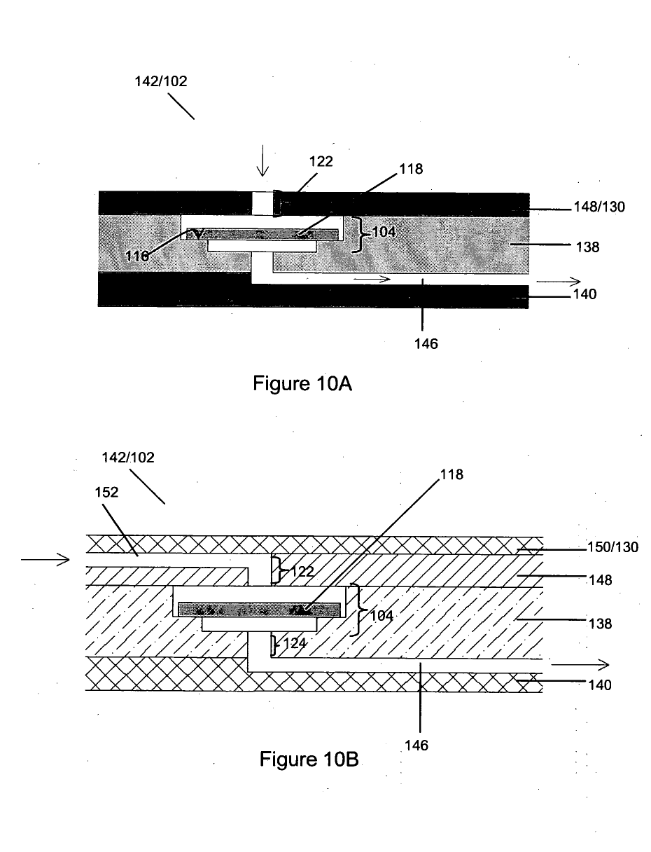

FIGS. 10A and 10B respectively shows a microfluidic device 102 integrated into a microfluidic system 142. FIG. 10A shows a microfluidic system 142 including a microfluidic device 102 formed using three substrates or layers 138, 140, 148 according to an embodiment.

In FIG. 10A, the oscillation chamber 104 may be fabricated on a first substrate 138 using any suitable method such as injection molding, end-milling for example. An output channel 146 may be fabricated on a second substrate 140 and a third substrate 148 may be used as the cover 130. An input passage 122 upstream of the chamber 104 may be formed on the third substrate 148. Then the diaphragm or membrane 118 may be put into the chamber 104. After alignment of the respective first substrate 138, second substrate 140 and third substrate 148, all the first substrate 138, second substrate 140 and third substrate 148 may be bonded together to seal the chamber 104. The direction of the fluid flow may be as shown by the arrows in FIG. 10A.

Each of the first substrate 138, the second substrate 140 and the third substrate 148 may include the same or different material. Each of the first substrate 138, the second substrate 140 and the third substrate 148 may include a material selected from a group consisting of polymeric material or metal materials for example. In an embodiment, the microfluidic device 102 may be fabricated with common polymeric materials such as polycarbonate (PC), poly(methylmethacrylate) (PMMA), cyclic olefin copolymer (COC), for example. Injection molding may be used for mass production. For metal materials, micro-milling may be used to machine the microfluidic device 102.

The diaphragm or membrane 118 may be made of an elastic material such as silicon rubber. The diaphragm 118 or membrane may be easily cut using punching method or using a carbon dioxide (CO₂) laser. Depending on the user requirements, the support surface 116 and the diaphragm 118 may be configured in any manner according to any one of FIG. 1, 2B or 5B as long as at least one channel (not shown) may be provided for fluid communication between the first chamber portion 108 and the second chamber portion 112.

FIG. 10B shows a microfluidic system 142 including a microfluidic device 102 formed using four substrates or layers 138, 140, 148, 150 according to an embodiment. The microfluidic system 142 as shown FIG. 10B may be similar to the microfluidic system 142 as shown in FIG. 10A except for a difference in the number of substrates or layers. In FIG. 10B, the oscillation chamber 104 and output passage 124 may be fabricated on a first substrate 138 using any suitable method such as injection molding, end-milling for example. An output channel 146 may be fabricated on a second substrate 140 and an input channel 152 and an input passage 122 may be fabricated on a third substrate 148. Further, a fourth substrate 150 may be used as the cover 130. Then the diaphragm or membrane 118 may be put into the chamber 104. After alignment of the respective first substrate 138, second substrate 140, third substrate 148 and fourth substrate 150, all the first substrate 138, second substrate 140, third substrate 148 and fourth substrate 150 may be bonded up to seal the chamber 104.

Similar to FIG. 10A, each of the first substrate 138, the second substrate 140, the third substrate 148 and the fourth substrate 150 may include the same or different material. Each of the first substrate 138, the second substrate 140, the third substrate 148 and the fourth substrate 150 may include a material selected from a group consisting of polymeric material or metal materials.

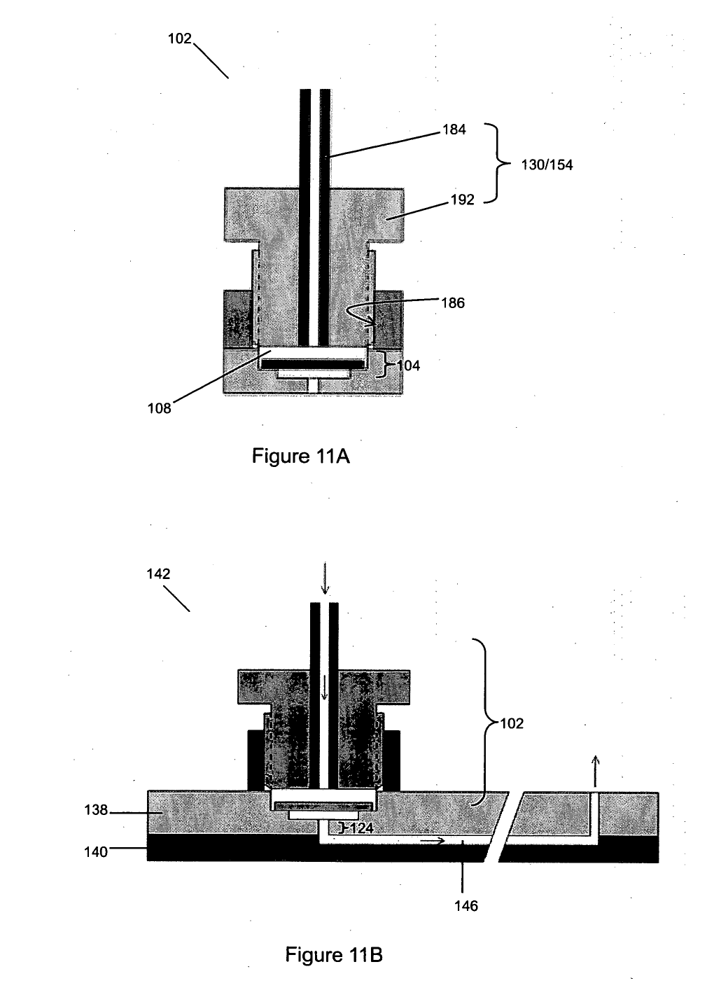

FIG. 11A shows a microfluidic device 102 including a chamber 104 and a cover 130 having a sealing component 154 configured to seal the chamber 104 according to an embodiment.

FIG. 11A shows the microfluidic device 102 or microfluidic oscillator being configured in a way that may allow a flexible adjustment of the depth of the first chamber portion or the upstream chamber portion 108 of the oscillation chamber 104 which may influence the flow rate and frequency. The side wall of the oscillation chamber 104 may be extended and an internal thread track may be fabricated on an internal surface 186 of the oscillation chamber 104. A screw 192 together with an inlet tubing 184 may be used as the sealing component 154 to seal the oscillation chamber 104. One advantage of the design as shown in FIGS. 11A and 11B may be that it may be relatively convenient to open the chamber 104 and replace the diaphragm or membrane 118. It may also allow the flexible adjustment of the depth of the first chamber portion or the upstream chamber portion or cavity 108 to control the operational flow rate.

FIG. 11B shows a microfluidic system 142 including the microfluidic device 102 as shown in FIG. 11A according to an embodiment. When used in the microfluidic system 142, a part of the microfluidic device 102 or microfluidic oscillator may be formed in a first substrate 138 and an output channel 146 may be formed in a second substrate 140. Altered fluid may flow out of the microfluidic device 102 via the output passage 124 into the output channel 146 of the microfluidic system 142 as shown by the arrows as shown in FIG. 11B.

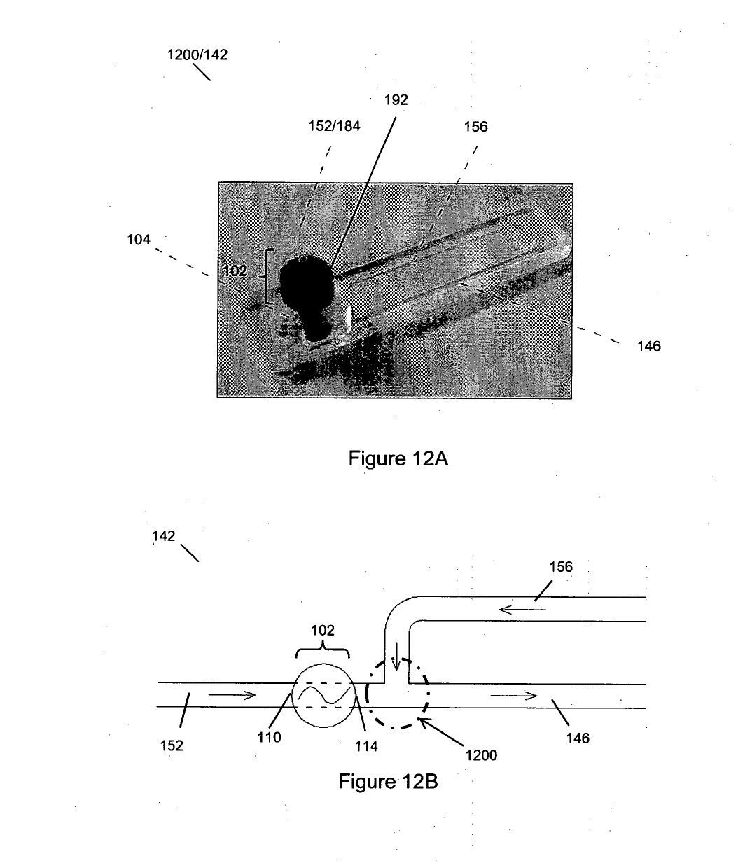

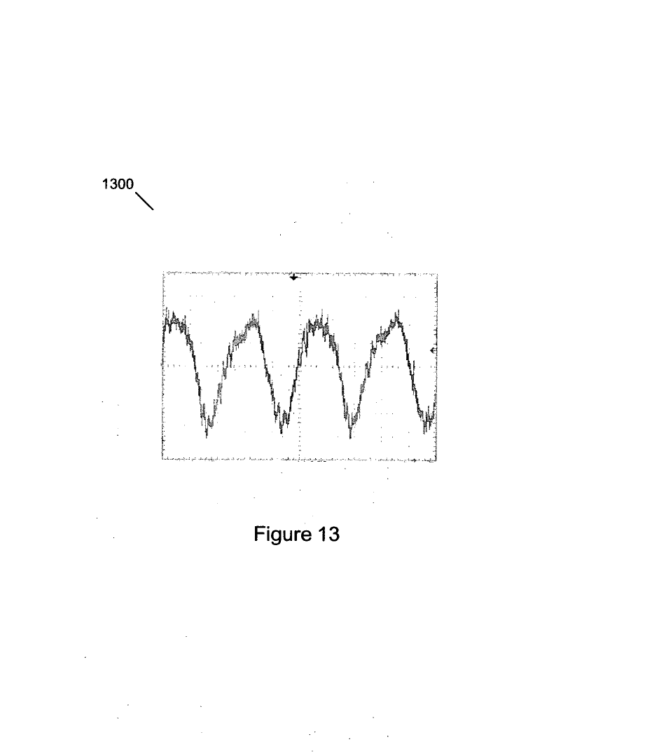

FIG. 12A shows a photograph 1200 of the microfluidic system 142 as shown in FIG. 11B according to an embodiment.

The microfluidic system 142 as shown in FIG. 12A may be fabricated using micro-milling machine and thermal bonding technique. The oscillation chamber 104 and the input passage or vertical orifice (not clearly shown) may be fabricated on a first PMMA plate (about 3 mm thick) using a micro-milling machine. An input microchannel 152 and an output microchannel 146 may be fabricated on a second PMMA plate (about 1.5 mm thick). M6 thread track may be fabricated in a PMMA block with a depth of about 6 mm. Then, the first PMMA plate and the second PMMA plate, the PMMA block may be aligned and bonded together using a thermal bonding method. An M6 screw 192 may be drilled through to allocate the inlet tubing 184, and the M6 screw 192 and the inlet tubing 184 may be permanently glued together. The diaphragm or elastic membrane (not clearly shown) may be made of silicone rubber and may be cut using a carbon dioxide (CO₂) laser. A sample microchannel 156 is fabricated at an immediate position downstream of the microfluidic device or oscillator 102, so that the oscillator 102 can work as a mixer. In some embodiments, the microfluidic system 142 may include a microfluidic chip.

As an example, some of the main parameters of the microfluidic device 102 may be as follows: (unit: mm):
Diameter/depth of the upstream cavity: 6/1.0
Diameter/depth of the downstream cavity: 4/0.5
Depth/width, (and number) of the grooves on stair: 0.15/0.5, (4)
Diameter of the vertical outlet channel: 0.8
Width/depth of the microchannel in the bottom layer: 0.5/0.5
Depth of the PMMA block: 6
Diameter/thickness of the membrane: 5.5/0.5
   This would provide a microfluidic device 102 having an operational pressure range of around 1.1 bar to 5 bar, such that the microfluidic device 102 is configured to provide altered fluid flow when fluid is pumped into the microfluidic device 102 at a pressure ranging from about 1.1 bar to 5 bar. Advantageously, this microfluidic device 102 may at the same time provide a microfluidic valving effect of around 5 bar so that if fluid is pumped into the microfluidic device 102 above the operational pressure range, the microfluidic device 102 would block fluid flow out of the outlet or output microchannel 146. Since a single microfluidic device 102 may serve multiple functions, the overall microfluidic system 142 may be designed with fewer devices, which would mean lower cost and less assembly processes would be involved.

FIG. 12B shows a schematic of a mixing profile of fluids in the microfluidic system 142 as shown in FIG. 12A according to an embodiment.

FIG. 12B shows an input channel 152 coupled to an inlet 110 of the microfluidic device 102. Further, a sample channel 156 is coupled to an outlet 114 of the microfluidic device 102. Fluid flowing in from the input channel 152 may be altered by the microfluidic device 102 so as to provide an altered fluid flow out of the microfluidic device 102. This altered fluid flow may be mixed with a sample fluid flowing in from the sample channel 156, thereby producing a mixed output fluid flow out of an output channel 146 of the microfluidic system 142.

When the microfluidic device 102 or oscillator operates at a high flow rate, the microfluidic device 102 produces sound. The frequency f may be detected using a microsensor. Results show that oscillatory frequency ranges from several tens Hz to around 400 Hz. FIG. 13 shows an output plot 1300 of a microfluidic device 102 showing an oscillation frequency (f) at about 143 Hz according to an embodiment.

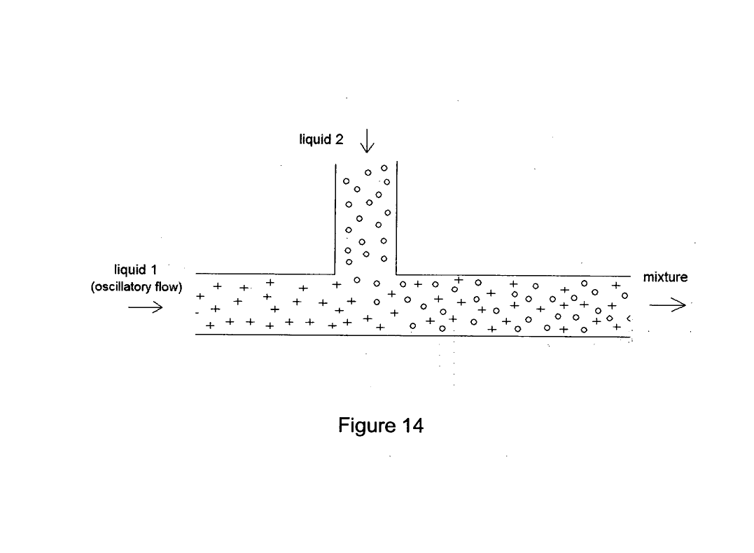

FIG. 14 shows a mixing profile of fluids in a boxed area 1200 of the microfluidic system 142 as shown in FIG. 12B according to an embodiment.

The altered fluid flow or oscillatory flow (or termed “liquid 1”) flowing out from the microfluidic device (not shown) may be mixed with a sample fluid (or termed “liquid 2”), thereby producing a mixture flowing out of the microfluidic system 142. The extent of the mixing depends on the magnitude and frequency of the oscillatory flow.

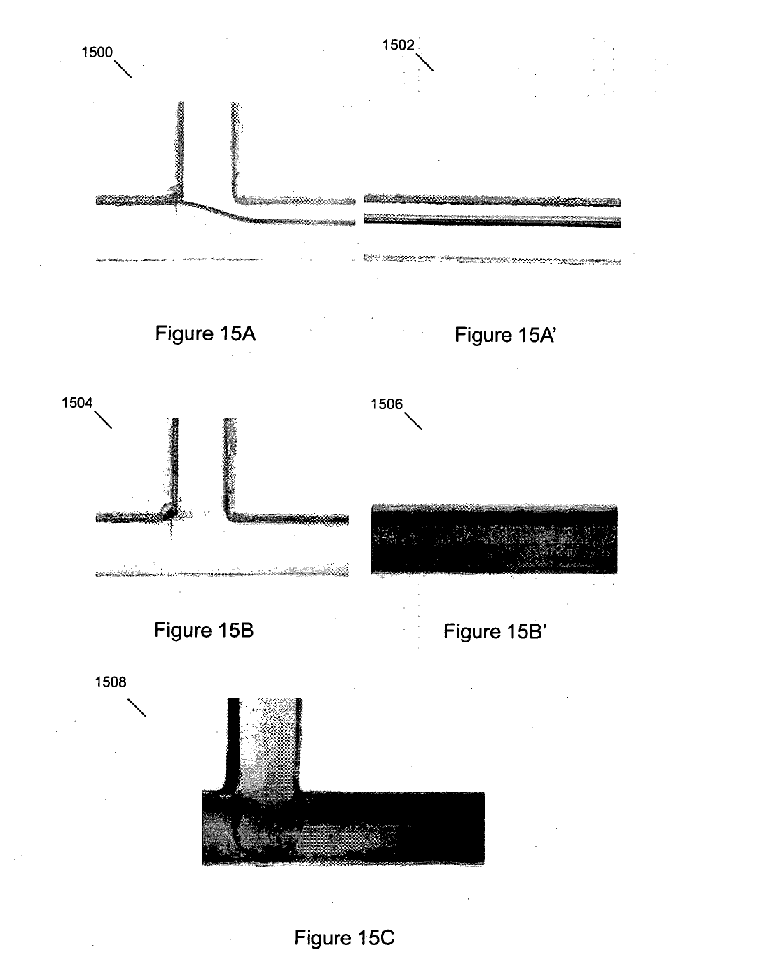

FIGS. 15A and 15A′ shows respective results 1500, 1502 of mixing of fluids in a microfluidic system in a steady flow without the microfluidic device. FIGS. 15B and 15B′shows respective results 1504, 1506 of improved mixing of fluids in a microfluidic system 142 in an oscillatory flow according to an embodiment. FIG. 15C shows a result 1508 of an instant mixing of fluids in a microfluidic system 142 in an oscillatory flow with a larger oscillation magnitude or at an increased or a higher flow rate according to an embodiment.

Two fluids, namely aqueous alkaline solution (0.5 wt. % NaOH solution) and 1% phenolphthalein solution may be used for mixing test. When the two fluids come into contact, their color will change from colorless to red (or seen as shaded). Relevant results 1500, 1502, 1504, 1506, 1508 are shown in FIGS. 15A, 15A′, 15B, 15W and 15C. FIG. 15A shows the result 1500 without the microfluidic device 102 or oscillator and the flow at Re of about 70 is stable. The fluid interface is clearly observed. As shown in the result 1502 in FIG. 15A′, after a channel length of about 3 cm downstream of the microfluidic device 102, the mixing is poor. The fluid interface just slightly smeared out through diffusion. FIG. 15B shows the result 1504 after the microfluidic device 102 or oscillator is added. At about the same Re, an oscillatory flow is produced. The material interface cannot be identified. The fluids become globally pink (or slightly shaded as shown in FIG. 15) which is the sign of mixing. As shown in the result 1506 in FIG. 15B′, after about 3 cm downstream of the microfluidic device 102 or oscillator, the fluids have been well mixed (or fully shaded as shown in FIG. 15B′). FIG. 15C shows the result 1508 with the microfluidic device 102 or oscillator at Re of about 150. As the Re is increased, the pulsating flow becomes much stronger with an increased magnitude. As a result, the fluids instantly mixed (shown as fully shaded in FIG. 15C) once the fluids come into contact.

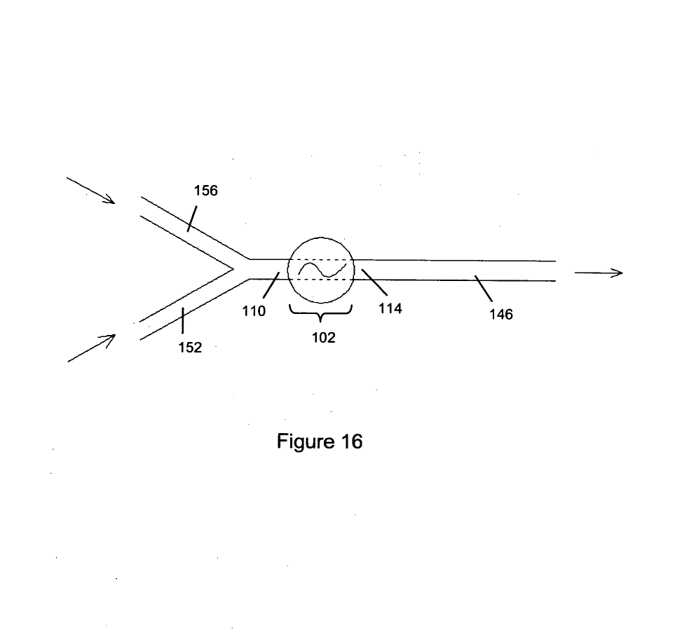

FIG. 16 shows an alternative mixing profile of fluids in a microfluidic system 142 from that as shown in FIG. 12B. FIG. 16 shows a schematic of a mixing profile of fluids in a microfluidic system 142 including an input channel 152 and a sample channel 156 coupled to an inlet 110 of the microfluidic device 102 according to an embodiment. Both the input channel 152 and the sample channel 156 may be coupled to the inlet 110 of the microfluidic device 102. After passing through the microfluidic device 102, both the fluid initially flowing in the input channel 152 and the sample fluid initially flowing in the sample channel 156 may be mixed, thereby producing a mixed output fluid flow out of the outlet 114 of the microfluidic device 102 into an output channel 146 out of the microfluidic system 142.

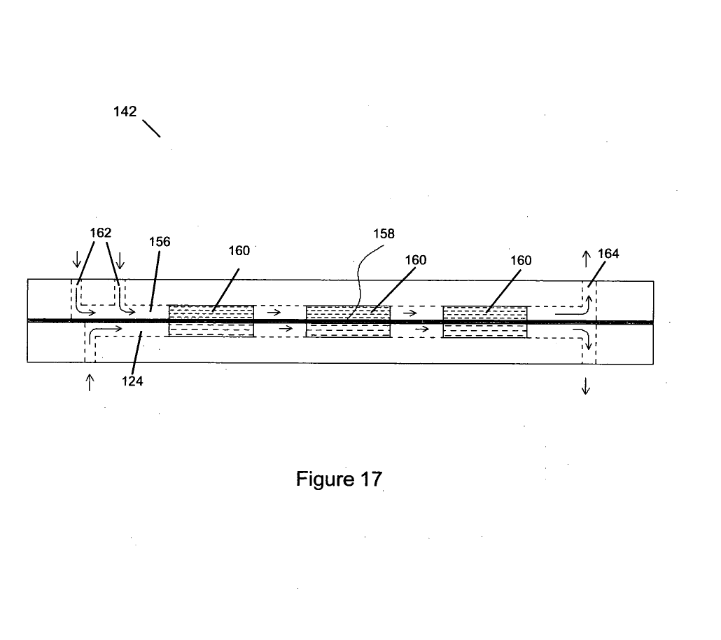

FIG. 17 shows a cross-sectional view of a microfluidic system 142 including a plurality of mixing chambers 160 respectively separated from an output passage 124 of an microfluidic device (not shown) by a flexible wall 158 according to an embodiment.

The output passage 124 may be coupled downstream of the microfluidic device. The microfluidic system 142 may include a sample fluid channel 156 separated from the output passage 124 via the flexible wall 158.

The microfluidic system 142 may further include three mixing chambers 160, each of the three mixing chambers 160 with at least one sample fluid and the flexible wall 158 separating each of the three mixing chambers 160 from the output passage 124, in which the flexible wall 158 may be configured to allow a transfer of energy from the altered fluid flow to the at least one sample fluid within each of the three mixing chambers 160.

As shown in FIG. 17, the sample fluid channel 156 may include two sample inlets 162 and one sample outlet 164. However, the sample fluid channel 156 may include any suitable number of the sample inlet 162 and the sample outlet 164 depending on user and design requirements. The direction of the sample fluid flow along the sample fluid channel 156 and the direction of the altered fluid flow out of the microfluidic device 102 and along the output passage 124 may be respectively shown in FIG. 17.

The flexible wall 158 may be of any suitable material, for example, an elastic film The thickness of the flexible wall 158 may also vary depending on user and design requirements. The flexible wall 158 may extend along the entire length of the overlap between the output passage 124 and the sample fluid channel 156 or may only be present within each of the three mixing chambers 160 depending on user and design requirements.

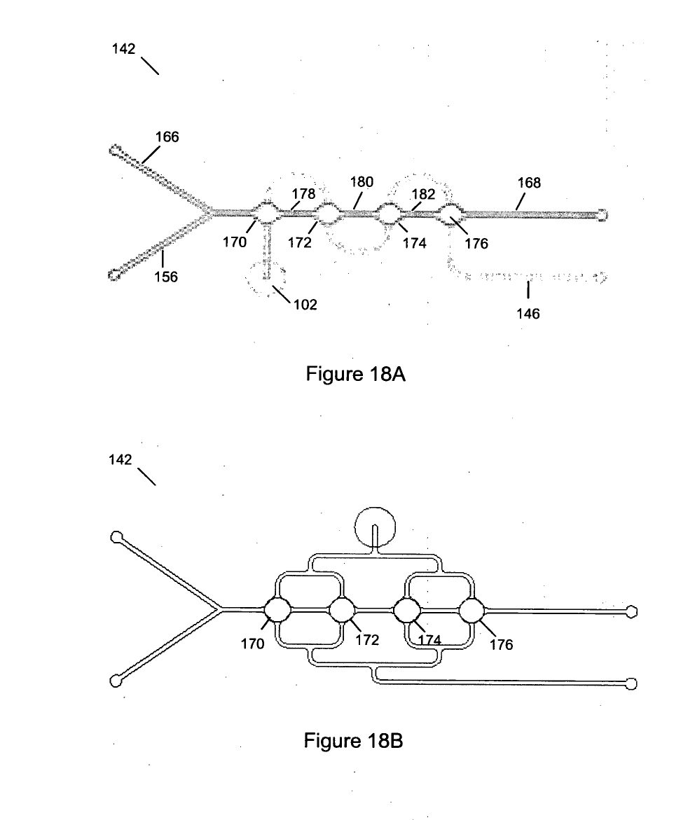

FIG. 18A shows a top view of a microfluidic system 142 including four mixing chambers 170, 172, 174, 176 arranged in a configuration according to an embodiment.

The microfluidic system 142 may include two sample input channels, i.e. a sample input channel 156 and a further sample input channel 166. A sample fluid and a further sample fluid may flow along the respective sample input channel 156 and the further sample input channel 166 so as to be mixed in a first mixing chamber 170. The microfluidic system 142 may further include a microfluidic device 102 coupled upstream of the first mixing chamber 170 so as to provide an altered fluid flow through the first mixing chamber 170, separated from the sample fluid and the further sample fluid by a flexible wall 158 (not shown in FIG. 18A, but as shown in FIG. 17). The flexible wall 158 is configured to allow a transfer of energy from the altered fluid flow to the sample fluid and the further sample fluid so as to enhance mixing of the sample fluid and the further sample fluid within the first mixing chamber 170.

The two sample fluids may be first fed into all the four mixing chambers 170, 172, 174 and 176. Then the oscillator or microfluidic device 102 is switched on and thus providing an altered fluid flow in the output microchannel 146 which simultaneously transmits energy at respective flexible walls of the mixing chambers 170, 172, 174 and 176 to the two sample fluids in these mixing chambers 170, 172, 174 and 176. In this manner, liquids in all the four mixing chambers 170, 172, 174 and 176 will be mixed at the same time, such that a fluidic network is effected.

At the same time, the altered fluid flow out of the microfluidic device 102 may flow out of the first mixing chamber 170 to the second mixing chamber 172, then to the third mixing chamber 174 and then the fourth mixing chamber 176 before flowing out of an altered fluid output channel 146.

FIG. 18B shows a top view of a microfluidic system 142 including four mixing chambers 170, 172, 174, 176 arranged in an alternative configuration according to an embodiment.

In both the microfluidic systems 142 as shown in FIG. 18A and FIG. 18B, the altered flow is provided to the four mixing chambers 170, 172, 174, 176 at the same time. The difference between that as shown in FIG. 18A and FIG. 18B is that in the in-series design as shown in FIG. 18A, the oscillation magnitude may decrease in the sequential four chambers 170, 172, 174, 176.

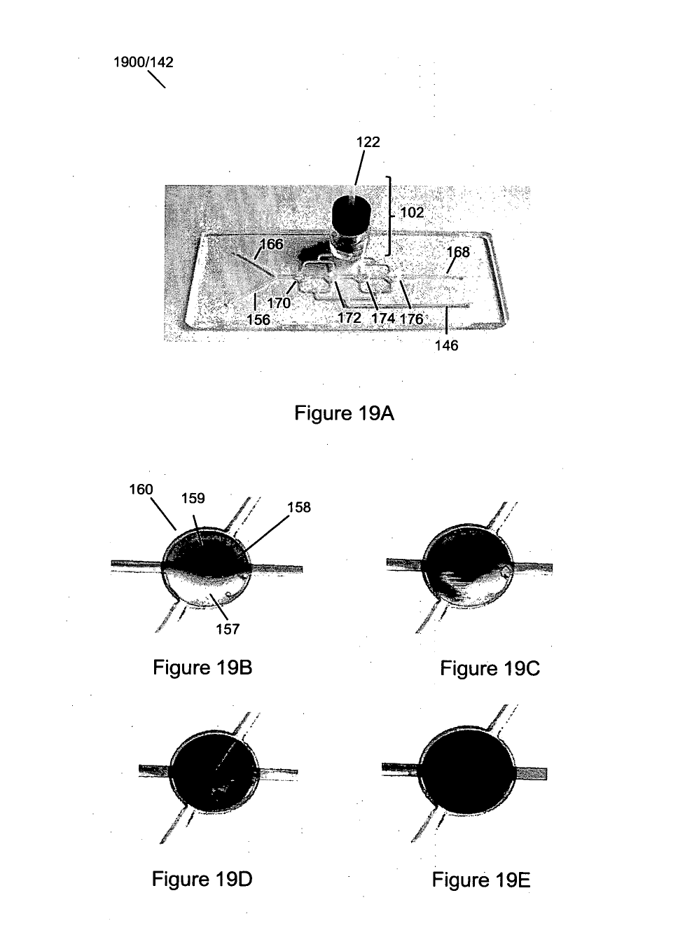

FIG. 19A shows a photograph 1900 of the microfluidic system 142 as shown in FIG. 18B according to an embodiment.

Similar to that as shown in FIG. 18B, the microfluidic system 142 may include a microfluidic device 102, an input passage 122 to the microfluidic device 102, a first sample channel 156, a further sample channel 166, four mixing chambers 170, 172, 174, 176, a sample output channel 168 and an altered fluid output channel 146.

FIGS. 19B to 19E show a sequential mixing process of fluids in a mixing chamber 160 according to an embodiment. The mixing chamber 160 may be any one of the four mixing chambers 170, 172, 174, 176 as shown in FIG. 18A or FIG. 18B. In FIG. 19B, two different fluids 159 and 157 flow into the mixing chamber 160 in parallel. Without the oscillation, the mixing is slow and the fluid interface 158 can be clearly observed. FIG. 19C to FIG. 19E show the mixing after around 0.2, 0.4 and 0.6s with the device 102 in operation. The homogeneity has been achieved after around 0.6s.

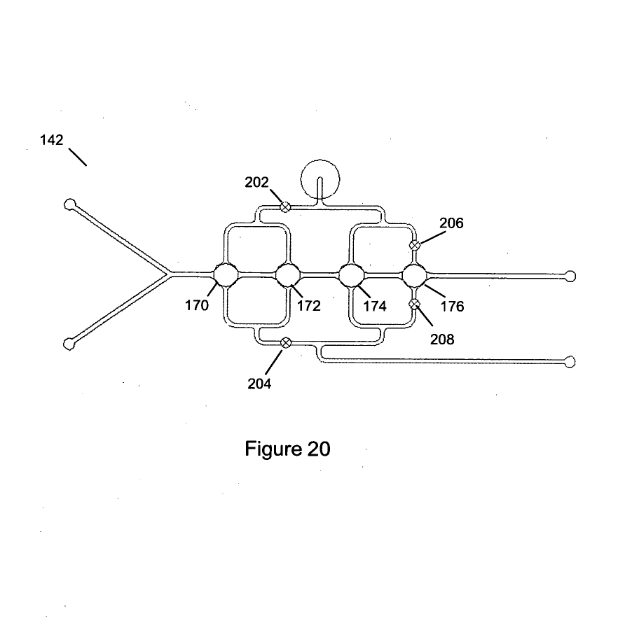

FIG. 20 shows a top view of a microfluidic system 142 configured to sequentially or simultaneously mix fluids in selected ones of a multiple number of mixing chambers 170, 172, 174, 176 in a fluidic network according to one embodiment.

In FIG. 20, the microfluidic system 142 includes micro-valves 202, 204, 206 and 208 positioned in the respective fluid passages for selective provision of altered fluid flow to different mixing chambers 170, 172, 174, 176 in the fluidic network. For example, when all the micro-valves 202, 204, 206 and 208 are open, the microfluidic system 142 is similar to that of FIG. 18B. When the micro-valves 202 and 204 are closed and the micro-valves 206 and 208 are open, only the liquids in mixing chambers 174 and 176 are mixed with the aid of the altered fluid flow. If all the micro-valves 202, 204, 206 and 208 are closed, only the liquids in chamber 174 are mixed. The micro-valves 202, 204, 206 and 208 may be pneumatic valves or mechanical valves involving the use of solenoids, for example.

In some embodiments, the microfluidic system 142 or microfluidic device 102 may be used in different potential industrial applications. One example may be in mixing or heat transfer enhancement in a microchannel. Though converting a steady laminar flow to an unstable oscillatory flow, the microfluidic oscillator may improve mass and heat transfer. The microfluidic oscillator may work as a microfluidic mixer. Another example may be in channel or device cleaning and recovery. For reusable microfluidic devices, channel cleaning is required to remove the residuals and contaminants after each use. The microfluidic oscillator 102 may provide a pulsating flow to improve the efficiency of the cleaning process. A further example is in chemical or biochemical reaction enhancement. The oscillator 102 can be used in micro reactor systems to improve the mixing between the chemical reactants, so as to improve the chemical or bio-chemical reaction. Yet another example is in fouling prevention or, reduction. In micro reactor or micro-heat exchanger systems, an oscillatory flow helps to reduce deposition of solids on the inner surface of the channels, and hence prevent or reduce the fouling. A further example is in filtration enhancement. An oscillatory flow also helps to prevent the fouling of a filter to improve the filtration rate. Another example is in emulsion formation. The microfluidic oscillator 102 may also be used to generate small droplets of liquid in another immiscible liquid to form emulsions.

In some embodiment, a passive microfluidic oscillator 102 that may operate at low Re range (e.g. Re<100) may be disclosed. Stable oscillations may be achieved at Re of about 50, thereby rendering the microfluidic oscillator an ideal choice for microfluidic applications.

The microfluidic oscillator 102 may also realize a relatively high frequency of up to several hundred hertz. A higher frequency may provide better performance for many applications, such as fluid mixing and heat transfer enhancement, fouling prevention, for example.

The microfluidic oscillator 102 may involve a passive design. Though a moving diaphragm 118 or membrane is used, the oscillation is realized in a passive way. It is autoinitiated, self-sustained and operates constantly under flow intake. In comparison with known active design, there is no need of the external control systems such as required for Lead Zirconate-Titanate (PZT) agitator. The structure is simple, cheap and more reliable.

The microfluidic oscillator 102 may be robust. For example, the oscillation may be strong and stable. Further, the oscillation may not be sensitive to the disturbance from surrounding environment.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A microfluidic device for altering a fluid flow, the microfluidic device comprising:
a chamber having:
a first chamber portion with an inlet configured to receive a fluid flow into the chamber;
a second chamber portion with an outlet configured to permit an altered fluid flow out of the chamber, the second chamber portion defining a smaller chamber cross section compared to the first chamber portion; and
at least one support structure with at least one support surface defining a division between the first chamber portion and the second chamber portion; and
a diaphragm in the first chamber portion, the diaphragm displaceable between a position at the inlet and a position at the at least one support surface by the fluid flow.

2. The microfluidic device of claim 1, in which the altered fluid flow is one of oscillatory fluid flow and pulsating fluid flow.

3. The microfluidic device of claim 1, in which the diaphragm is unconnected to the chamber.

4. The microfluidic device of claim 1, in which the diaphragm is flat in shape.

5. The microfluidic device of claim 1, in which the diaphragm is displaceable to facilitate the fluid flow from the first chamber portion into the second chamber portion.

6. The microfluidic device of claim 1, in which the diaphragm is deformable under a difference in pressure between two substantially opposing faces of the diaphragm.

7. The microfluidic device of claim 1, in which the diaphragm further comprises at least one opening.

8. The microfluidic device of claim 7, in which the at least one opening is formed along a circumference of the diaphragm or within the diaphragm.

9. The microfluidic device of claim 1, in which the diaphragm comprises a material selected from a group consisting of silicone rubber, natural rubber, latex, nitrile rubber, thermoplastic polyurethane, and elastic metal.

10. The microfluidic device of claim 1, in which the second chamber portion defines a cross-sectional dimension smaller than the cross-sectional dimension of the first chamber portion.

11. The microfluidic device of claim 1, in which the at least one support structure defines at least one channel communicating between the first chamber portion and the second chamber portion.

12. The microfluidic device of claim 11, in which the at least one support surface further comprises at least one groove of at least one depth, the at least one groove partially defining the at least one channel.

13. The microfluidic device of claim 1, further comprising an input passage coupled to the inlet such that the input passage is configured to channel the fluid flow into the first chamber portion.

14. The microfluidic device of claim 1, further comprising an output passage coupled to the outlet such that the output passage is configured to channel the fluid flow out of the second chamber portion.

15. The microfluidic device of claim 1, further comprising a cover disposed over the inlet and configured to at least substantially cover the diaphragm within the chamber.

16. The microfluidic device of claim 15, wherein the cover comprises a cover opening, the cover opening is positioned to align with the input passage so as to allow the fluid flow into the chamber through the cover opening and the input passage.

17. The microfluidic device of claim 1, in which the first chamber portion further comprises a third chamber portion leading from the inlet, the third chamber portion defining a smaller chamber cross section compared to the rest of the first chamber portion.

18. A microfluidic system, comprising:
a microfluidic device configured to alter a fluid flow including:
a chamber having:
a first chamber portion with an inlet configured to receive a fluid flow into the chamber;
a second chamber portion with an outlet configured to permit an altered fluid flow out of the chamber, the second chamber portion defining a smaller chamber cross section compared to the first chamber portion; and
at least one support structure with at least one support surface defining a division between the first chamber portion and the second chamber portion; and
a diaphragm in the first chamber portion, the diaphragm displaceable between a position below the inlet and a position at the at least one supporting surface by the fluid flow; and
an input passage connected upstream of the microfluidic device; and
an output passage connected downstream of the microfluidic device.

19. The microfluidic system of claim 18 further comprising:
at least one sample fluid channel in fluidic connection with at least one of the input passage and the output passage, the at least one sample fluid channel being configured to allow a sample fluid flow in the at least one sample fluid channel to be mixed with the altered fluid flow.

20. The microfluidic system of claim 18, further comprising:
at least one mixing chamber with at least one sample fluid;
a flexible wall separating a sample fluid channel from the output passage at least within the at least one mixing chamber, in which the flexible wall is configured to allow a transfer of energy from the altered fluid flow to the at least one sample fluid within the at least one mixing chamber.
